(19) United States
(12) Patent Application Publication
(10) Pub. No.: US 2009/0201772 A1
(43) Pub. Date: Aug. 13, 2009

(54) SYSTEMS AND METHODS FOR PROVIDING TIME USING COLORS

(76) Inventor: Michael A. Billeaudeaux, Auburn, WA (US)

Correspondence Address: Ruttler Law PLLC;One Union Square, 600 University Street, Suite 1919, Seattle, WA, 98101, US

(21) Appl. No.: 12/104,808

(22) Filed: Apr. 17, 2008

Related U.S. Application Data
(63) Continuation-in-part of application No. 12/002,739, filed on Dec. 18, 2007.
(60) Provisional application No. 60/875,585, filed on Dec. 19, 2006.

(51) Int. Cl. G04C 19/00

(52) U.S. Cl. 368/82; 368/223

(57) ABSTRACT

This invention relates generally to software and mechanics, and more specifically, to systems and methods for providing time using color. In one embodiment, the invention includes a clock for providing time using colors, the clock including a time component, the time component configurable to produce a measurable mark of time; a color decoding component, the color decoding component configurable to associate the measurable mark of time with a given color group, the colors of the given color group being representative of numbers; and a display component, the display component configurable to visually display the given color group in an arrangement, wherein the displayed color group is usable to determine a time.

### PRIORITY CLAIM

This application is a continuation-in-part of non-provisional application Ser. No. 12/002,739 filed Dec. 18, 2007 (our ref: BILD-1-1001-1), which claims the benefit of U.S. Provisional Application No. 60/875,585 filed Dec. 19, 2006 (our ref: BILD-1-1001). The foregoing applications are incorporated by reference in their entirety as if fully set forth herein.

### FIELD OF THE INVENTION

This invention relates generally to software and mechanics, and more specifically, to systems and methods for providing time using color.

### BACKGROUND

Methods of measuring time date back to at least 1500 B.C. where the Egyptians used a bent T-square in sunlight to cast shadows against a non-linear rule. Later a sundial having a gnomon was used in a similar fashion to cast shadows on a set of markings that were calibrated to the hour. The T-square and the sundial therefore based time measurements directly on the relationship of the earth's position relative to the sun. Because the foregoing relied on sunlight and were not easily portable, more abstract methods for measuring time were developed. For instance, water clocks were later invented to measure time during nighttime hours. Water clocks or clepsydra offered superior accuracy and operated by measuring the water level in a vessel having regulated inflow or outflow. Also, sand clocks used the flow of sand to measure time and offered a convenient transportable substitute to water clocks thereby making them especially popular among early explorers. Based on the same theory as water clocks and sand clocks, incense sticks and candles used the degree of degradation to measure time and were popular in temples and churches given their dual ambiance functionality. These clocks therefore distanced themselves from earlier forms of timekeeping as they were based on the passage of time itself rather than directly measuring the relationship of the earth's position relative to the sun.

These ancient methods of measuring time have long since been surpassed by modern day analog clocks, digital clocks, and auditory clocks, which continue to provide an abstract measurement of time. Analog clocks measure time using angles, such as with rotating hands over a scaled dial, whereas digital clocks display a numeric representation of time. Differently, auditory clocks present time as sound, either through spoken natural language or auditory bells or chimes. These clocks are all built around some form of periodic oscillator such as a pendulum, crystal, or atom, whereby periods are counted and converted into the respective representation of time.

Computer display technology has exponentially advanced in recent years. Since rudimentary Liquid Crystal Displays (LCD) were invented in 1968, they have been vastly improved and are now widely used as computer monitors, television screens, mobile phone displays, and personal digital assistance screens. Further, Organic Light-Emitting Diodes (OLED) and Light Emitting Polymers (LEP) are now competing with LCD technology for market share. OLED and LEP include an emissive electroluminescent layer of organic compounds that emit light of different colors. Because they do not require a backlight to function, they require less power, are thinner, and are easier to manufacturer than LCDs. In short, clocks are no longer limited to the traditional analog and antiquated digital displays of the past as LCD screens and even OLED and LEP type displays are now widely available.

Time is a critical component of underwater diving as divers rely on time to gauge oxygen levels and avoid decompression sickness from nitrogen accumulation, which can occur when ascension rate is too rapid. To measure time, underwater divers currently rely on traditional back-lighted digital or analog clock watches. However, because of the limited visibility inherent in an underwater environment coupled with the relative small size of clock watches and their analog or digital elements, divers find it difficult to quickly and accurately measure time. Yet, because of the absence of any other better alternative, divers have become accustomed to working within these limitations.

Accordingly, although desirable results have been achieved, there exists much room for improvement. What is needed then are systems and methods for providing time using colors.

### SUMMARY

This invention relates generally to software and mechanics, and more specifically, to systems and methods for providing time using color. In one embodiment, the invention includes a clock for providing time using colors, the clock including a time component, the time component configurable to produce a measurable mark of time; a color decoding component, the color decoding component configurable to associate the measurable mark of time with a given color group, the colors of the given color group being representative of numbers; and a display component, the display component configurable to visually display the given color group in an arrangement, wherein the displayed color group is usable to determine a time. In one particular embodiment, the given color group comprises an hour color, a 10-minute increment color, and a minute color, the hour color indicating a number of hours that have passed since a baseline, the 10-minute increment color indicating a number of ten minutes increments that have passed since a previous hour, and the minute color indicating a number of minutes that have passed since a previous ten minute increment. In a further embodiment, the arrangement has a first section, a second section, and a third section, the first section being the hour color, the second section being the 10-minute increment color, and the third section being the minute color.

### BRIEF DESCRIPTION OF THE DRAWINGS

Embodiments of the present invention are described in detail below with reference to the following drawings:

FIG. 1 is a perspective view of various clocks for providing time using colors, in accordance with an embodiment of the invention;

FIG. 2 is a table of numbers and representative colors for providing time using colors, in accordance with an embodiment of the invention;

FIG. 3 is a table of time and associated color group for providing time using colors, in accordance with an embodiment of the invention;

FIG. 4 is a schematic of various arrangements of color groups for providing time using colors, in accordance with an embodiment of the invention;

FIG. 5 is a table of numbers and representative symbols for providing time using symbols, in accordance with an embodiment of the invention;

FIG. 6 is a table of time and associated symbol group for providing time using symbols, in accordance with an embodiment of the invention;

FIG. 7 is a system diagram of software application for providing time using colors, in accordance with an embodiment of the invention; and

FIG. 8 is a system diagram of clock components for providing time using colors, in accordance with an embodiment of the invention.

### DETAILED DESCRIPTION

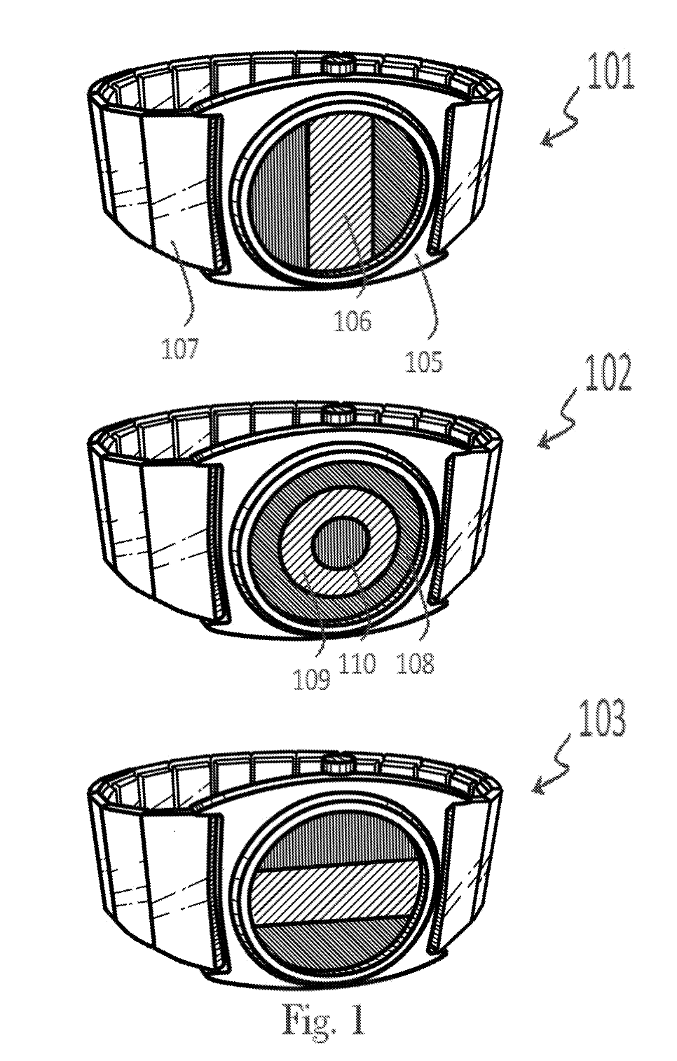

This invention relates generally to software and mechanics, and more specifically, to systems and methods for providing time using colors. Specific details of certain embodiments of the invention are set forth in the following description and in FIGS. 1-8 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of various clocks for providing time using colors, in accordance with an embodiment of the invention. In one embodiment, clock 101 includes a housing 105, a display 106, and a wristband 107. The housing 105 includes the display 106 therein and is configurable to being removably secured to an individual using the wristband 107. The housing 105 further includes components for measuring time, such as a power component, a time component, and a software component (hidden from view). The display 106 is any of an LED, LCD, OLED, LEP, Plasma, or other similar display technology and is configurable to emitting a group of colors in response to the components for measuring time. The group of colors are arranged on the display 106 in three distinct sections, such as horizontally as in clock 101, circularly as in clock 102, or vertically as in clock 103, with each section having only one of the group of colors at any given time. For example, during one particular time of the day, section 108 is yellow, section 109 is light orange, and section 110 is navy blue. During another particular time of the day, section 108 is navy blue, section 109 is red, and section 110 is dark green. Although each section has only one of the group of colors at any given time, any of the sections may share a common color.

In other embodiments, the display 106 is embodied in a pocket clock, a wall mounted clock, a standing clock, an alarm clock, a computer clock, a television clock, an appliance clock, an automobile clock, a watercraft clock, an airplane clock, a telephone clock, a personal digital assistant clock, or any other clock. In a further embodiment, the group of colors are arranged on the display 106 in fewer or greater numbers of sections or in differently arranged sections.

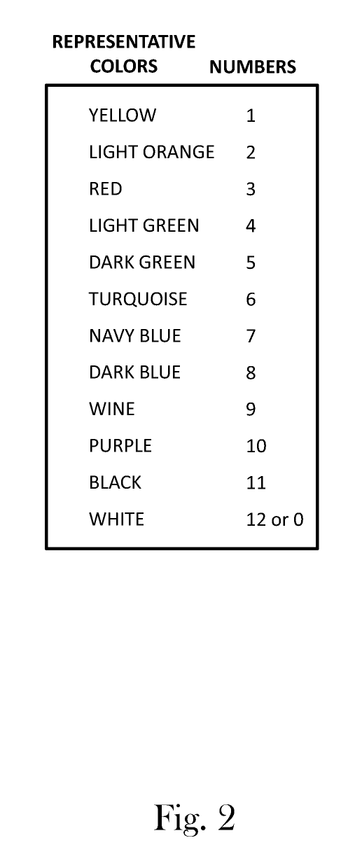

FIG. 2 is a table of numbers and representative colors for providing time using colors, in accordance with an embodiment of the invention. In one embodiment, numbers 0 through 12 are each represented by a color. The number 1 is represented by the color yellow, the number 2 is represented by the color light orange, the number 3 is represented by the color red, the number 4 is represented by the color light green, the number 5 is represented by the color dark green, the number 6 is represented by the color turquoise, the number 7 is represented by the color navy blue, the number 8 is represented by the color dark blue, the number 9 is represented by the color wine, the number 10 is represented by the color purple, the number 11 is represented by the color black, and the numbers 12 and 0 are represented by the color white.

In certain embodiments, additional numbers are represented by colors, such as through the number 24, through the number 31, through the number 365, or even through infinity. In other embodiments, any of the numbers are represented by a different color. In one embodiment, the colors are customizable or changeable.

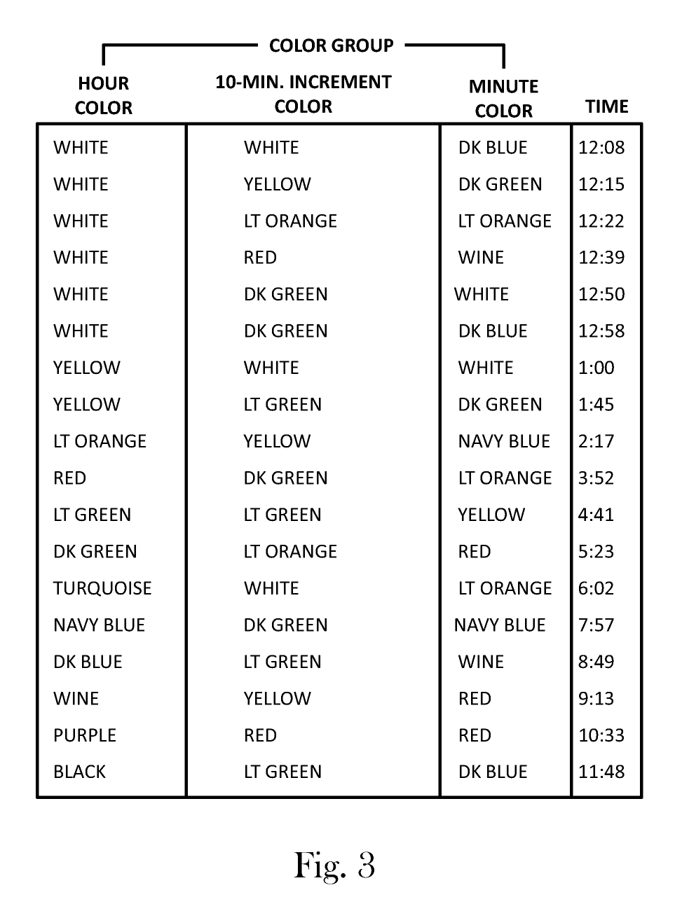

FIG. 3 is a table of time and associated color group for providing time using colors, in accordance with an embodiment of the invention. In one embodiment, any time from 12 AM to 12 PM in increments of minutes is providable using a given color group. A given color group is composed of three colors, each of which represent a number as discussed in reference to FIG. 2 supra. The first color is an hour color, the second color is a 10-minute increment color, and the third color is a minute color. The hour color represents a number from 0 to 12 and indicates the number of hours that have passed since midnight or high noon. The 10-minute increment color represents a number from 0 to 5 and indicates the number of 10-minute increments that have passed since the last hour. The minute color represents a number from 0-9 and indicates the number of minutes that have passed since the last 10-minute increment. As time changes, so do the colors in a given color group. Thus, the hour color is white immediately after midnight or high noon and changes to yellow, light orange, red, light green and so on throughout the day until the hour before the next midnight or high noon wherein the hour color is black. Similarly, the 10-minute increment color is white immediately after an hour change and changes to yellow, light orange, red, light green, and dark green every ten minutes before returning to white upon the next hour change. Likewise, the minute color is white immediately after a 10-minute increment change and changes to yellow, light orange, red, light green, dark green, turquoise, navy blue, dark blue, and wine before returning to white upon the next 10-minute increment change. Accordingly, any time during the day is providable using a given color group.

For example, the time of 12:08 is provided with a color group of white, white, and dark blue (in each of these examples the order of the colors is hour color, 10-minute increment color, and minute color). The white hour color indicates that no hours have passed since midnight or high noon, while the white 10-minute increment color indicates that no 10-minute increments have passed since the last hour, and while the dark blue minute color indicates that eight minutes have passed since the last 10-minute increment. As another example, the time of 12:58 is provided with a color group of white, dark green, and dark blue. The white hour color indicates that no hours have passed since midnight or high noon, while the dark green 10-minute increment color indicates that five 10-minute increments have passed since the last hour, and while the dark blue minute color indicates that eight minutes have passed since the last 10-minute increment. As a further example, the time of 10:33 is provided with a color group of purple, red, and red. The purple hour color indicates that ten hours have passed since the last midnight or high noon, while the red 10-minute increment color indicates that three 10-minute increments have passed since the last hour, and while the red minute color indicates that three minutes have passed since the last 10-minute increment. For further example, FIG. 3 illustrates a host of color groups that provide various times.

In other embodiments, a given color group includes fewer or greater colors. For instance, a single color is usable to provide only hours or two colors are usable to provide only hours and 10-minute increments. Alternatively, an additional color is usable to provide an AM or PM designation, a day of a week, a day of a month, a week of a month, a month of a year, a year, or even seconds or increments of seconds. In yet a further embodiment, the minute color, the 10-minute increment color, and the hour color are omitted, supplemented, or changed. For example, a single minute color is usable to provide any time of a day, such as with seven hundred and twenty different colors. Alternatively, the minute color and the 10-minute increment color are usable to provide any time of a day, such as with a hundred and twenty different colors. Further the 10-minute increment color can be a 15-minute, 20-minute, 30-minute, or other increment color. Also, the hour color is usable to provide all twenty-four hours of a day, such as with twenty four colors. Also, the minute color, the 10-minute increment color, and the hour color can be supplemented with a 5-minute or other increment color.

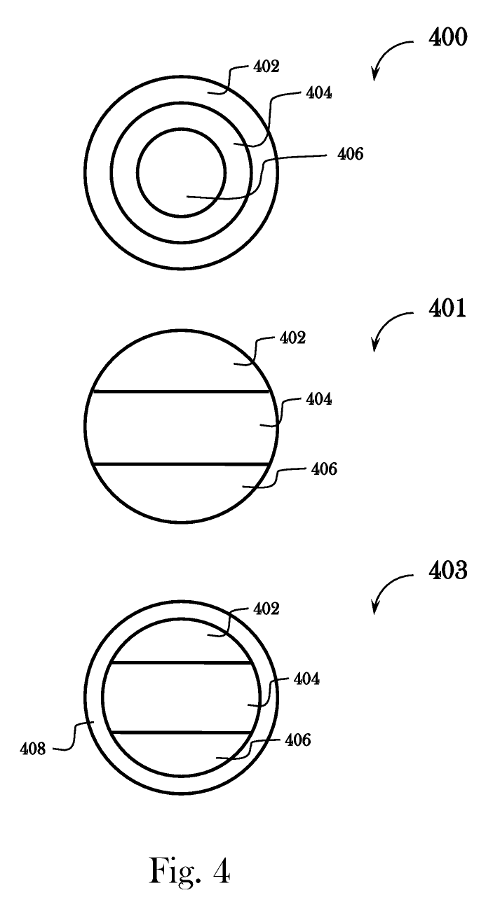

FIG. 4 is a schematic of various arrangements of color groups for providing time using colors, in accordance with an embodiment of the invention. In one embodiment, arrangement 400 is circular and includes a first section 402, a second section 404 inside the first section 402, and a third section 406 inside the second section 404. The arrangement 400 organizes a given color group for providing time with the first section 402 being an hour color, the second section 404 being a 10-minute increment color, and the third section 406 being a minute color. For example, for the time 8:49 the first section 402 is dark blue, the second section 404 is light green, and the third section 406 is wine. Additionally, for the time 1:00 the first section 402 is yellow, the second section 404 is white, and the third section 406 is white. Arrangement 401 is horizontal and includes the first section 402, the second section 404 below the first section 402, and the third section 406 below the second section 404. Similarly to the arrangement 400, the arrangement 401 organizes a given color group for providing time with the first section 402 being an hour color, the second section 404 being a 10-minute increment color, and the third section 406 being a minute color. Arrangement 403 is similar to the arrangement 401 with the exception that a fourth section 408 circumscribes the first section 402, the second section 404, and the third section 406. The arrangement 403 organizes a given color group having four colors for providing time with the first section 402 being an hour color, the second section 404 being a 10-minute increment color, the third section 406 being a minute color, and the fourth section 408 being an AM/PM color, a seconds color, a day of week color, a day of month color, a week of month color, a month color, a year color, or some other representative color. For example, the fourth section 408 is blue during AM and black during PM. The arrangements 400, 401, and 403 are displayable on any display as discussed herein.

In other embodiments, the arrangements are differently organized or have fewer or greater numbers of sections. In an alternative embodiment, the hour color, the 10-minute increment color, and the minute color are in different sections. In another embodiment, the arrangements are pictures or objects, such as a dragon, a dinosaur, a heart, a star, or some other picture or object, whereby portions of the pictures or objects are the sections. In a further embodiment, the arrangements or sections are complimented or substituted with sounds, symbols numbers, analog displays, or some other non-color representation of numbers. In one particular embodiment, the arrangements are alternatable, customizable, or changeable.

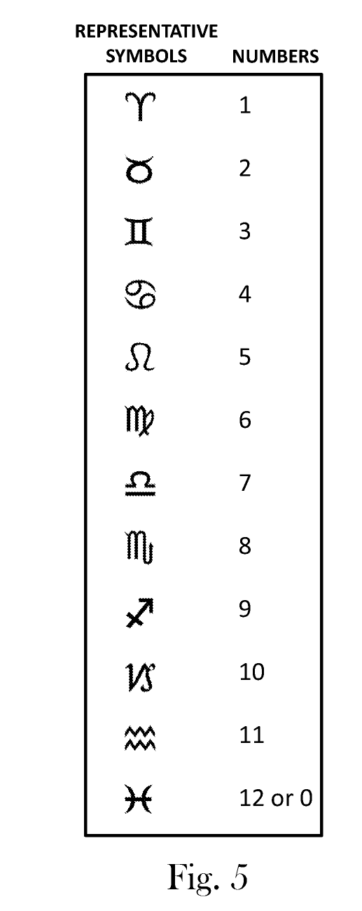

FIG. 5 is a table of numbers and representative symbols for providing time using symbols, in accordance with an embodiment of the invention. In one embodiment, numbers 0 through 12 are each represented by a zodiac symbol. The number 1 is represented by the Aries symbol, the number 2 is represented by the Taurus symbol, the number 3 is represented by the Gemini symbol, the number 4 is represented by the Cancer symbol, the number 5 is represented by the Leo symbol, the number 6 is represented by the Virgo symbol, the number 7 is represented by the Libra symbol, the number 8 is represented by the Scorpio symbol, the number 9 is represented by the Sagittarius symbol, the number 10 is represented by the Capricorn symbol, the number 11 is represented by the Aquarius symbol, and the numbers 12 and 0 are represented by the Pisces symbol.

In certain embodiments, additional numbers are represented by symbols, such as through the number 24, through the number 31, through the number 365, or even through infinity. In other embodiments, any of the numbers are represented by a different symbol. In one embodiment, the symbols are customizable or changeable. In alternative embodiments, the symbols are substituted or complimented with other symbols such as coat of arm symbols, currency symbols, flag symbols, insignia symbols, grapheme symbols, mascot symbols, sports team symbols, mathematical symbols, punctuation symbols, religious symbols, astrological symbols, career related symbols, hobby related symbols, family related symbols, or any other symbol, graphic, picture, video, or sound.

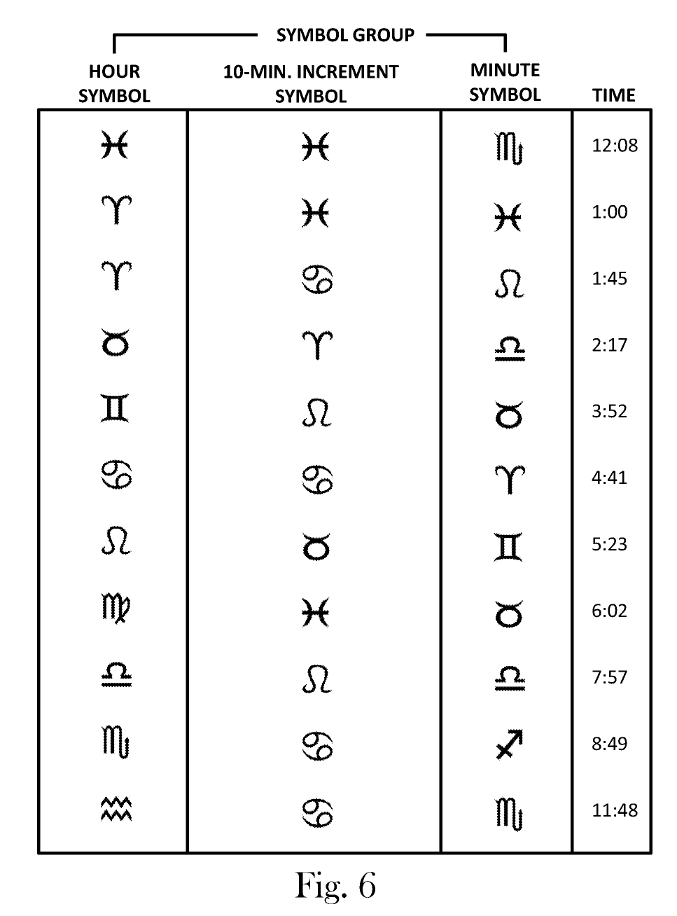

FIG. 6 is a table of time and associated symbol group for providing time using symbols, in accordance with an embodiment of the invention. In one embodiment, any time from 12 AM to 12 PM in increments of minutes is providable using a given symbol group. A given symbol group is composed of three symbols, each of which represent a number as discussed in reference to FIG. 5 supra. The first symbol is an hour symbol, the second symbol is a 10-minute increment symbol, and the third symbol is a minute symbol. The hour symbol represents a number from 0 to 12 and indicates the number of hours that have passed since midnight or high noon. The 10-minute increment symbol represents a number from 0 to 5 and indicates the number of 10-minute increments that have passed since the last hour. The minute symbol represents a number from 0-9 and indicates the number of minutes that have passed since the last 10-minute increment. As time changes, so do the symbols in a given symbol group. Thus, the hour symbol is Pisces immediately after midnight or high noon and changes to Aries, Taurus, Gemini, Cancer, and so on throughout the day until the hour before the next midnight or high noon wherein the hour symbol is Aquarius. Similarly, the 10-minute increment symbol is Pisces immediately after an hour change and changes to Aries, Taurus, Gemini, Cancer, and Leo every ten minutes before returning to Pisces upon the next hour change. Likewise, the minute symbol is Pisces immediately after a 10-minute increment change and changes to Aries, Taurus, Gemini, Cancer, Leo, Virgo, Libra, Scorpio, and Sagittarius before returning to Pisces upon the next 10-minute increment change. Accordingly, any time during the day is providable using a given symbol group.

For example, the time of 1:45 is provided with a symbol group of Aires, Cancer, and Leo (in each of these examples the order of the symbols is hour symbol, 10-minute increment symbol, and minute symbol). The Aries hour symbol indicates that one hour has passed since midnight or high noon, while the Cancer 10-minute increment symbol indicates that four 10-minute increments have passed since the last hour, and while the Leo minute symbol indicates that five minutes have passed since the last 10-minute increment. As another example, the time of 3:52 is provided with a symbol group of Gemini, Leo, and Taurus. The Gemini hour symbol indicates that three hours have passed since midnight or high noon, while the Leo 10-minute increment symbol indicates that five 10-minute increments have passed since the last hour, and while the Taurus minute symbol indicates that two minutes have passed since the last 10-minute increment. As a further example, the time of 8:49 is provided with a symbol group of Scorpio, Cancer, and Sagittarius. The Scorpio hour symbol indicates that eight hours have passed since the last midnight or high noon, while the Cancer 10-minute increment symbol indicates that four 10-minute increments have passed since the last hour, and while the Sagittarius minute symbol indicates that nine minutes have passed since the last 10-minute increment. For further example, FIG. 6 illustrates a host of symbol groups that provide various times.

In other embodiments, a given symbol group includes fewer or greater symbols. For instance, a single symbol is usable to provide only hours or two symbols are usable to provide only hours and 10-minute increments. Alternatively, an additional symbol is usable to provide an AM or PM designation, a day of a week, a day of a month, a week of a month, a month of a year, a year, or even seconds or increments of seconds. In yet a further embodiment, the hour symbol, the 10-minute increment symbol, and the minute symbol are omitted, supplemented, or changed. For example, a single minute symbol is usable to provide any time of a day, such as with seven hundred and twenty different symbols. Alternatively, the minute symbol and the 10-minute increment symbol are usable to provide any time of a day, such as with a hundred and twenty different symbols. Further the 10-minute increment symbol can be a 15-minute, 20-minute, 30-minute, or other increment symbol. Also, the hour symbol is usable to provide all twenty-four hours of a day, such as with twenty four symbols. Also, the hour symbol, the 10-minute increment symbol, and the minute symbol can be supplemented with a 5-minute or other increment symbol. In one particular embodiment, a given symbol group is complimented or substituted with colors that are representative of numbers. For instance, a given symbol group can include an hour color, a 10-minute increment color, and a minute symbol. Alternatively, a given symbol group can include an hour symbol, a 10-minute increment symbol, and a minute color. Further, a given symbol group can include an hour color, a 10-minute increment symbol, and a minute symbol. Additionally, an AM/PM color can supplement an hour symbol, a 10-minute increment symbol, and a minute symbol. In a further embodiment, a given symbol group is complimented or substituted with colors, sounds, numbers, analog displays, or some other representation of numbers. In one particular embodiment, a given symbol group is alternatable, customizable, or changeable.

In various embodiments, a given symbol group is arrangeable vertically, horizontally, diagonally, or using another similar methodology. In one particular embodiment, when colors compliment or substitute symbols in a given symbol group, the symbol group is arrangeable in any manner described in reference to FIG. 4 supra. For example, a 10-minute increment color and an hour color are arrangeable vertically with a minute symbol being superimposed thereon. Alternatively, portions of an hour symbol are a 10-minute increment color and a minute color. In one particular embodiment, the arrangement of a given symbol group is alternatable, customizable, or changeable.

In one embodiment, any time is providable using a position of a given object group. The given object group includes an hour object, a 10-minute increment object, and a minute object. The objects are arranged in three vertical or horizontal sections and are configurable to progress from one end of a section to another end of a section. The position of the hour object represents a number and indicates the number of hours that have passed since a baseline. The position of the 10-minute increment object represents a number and indicates the number of 10-minute increments that have passed since the last hour. The position of the minute object represents a number and indicates the number of minutes that have passed since the last 10-minute increment. As time changes, so the positions of the objects in a given object group. Thus, the hour object is close to one end of a section immediately after midnight and progresses towards the other end of the section throughout the day. Similarly, the 10-minute increment object is close to one end of a section immediately after an hour change and progresses towards the other end of the section throughout the hour. Likewise, the minute object is close to one end of a section immediately after a 10-minute increment change and progresses towards the other end of the section throughout the next ten minutes. Accordingly, any time during the day is providable using the position of a given object group. Objects of a given object group can be replaced or supplemented with any embodiment described herein. Likewise, any embodiment described herein can be replaced or supplemented with objects.

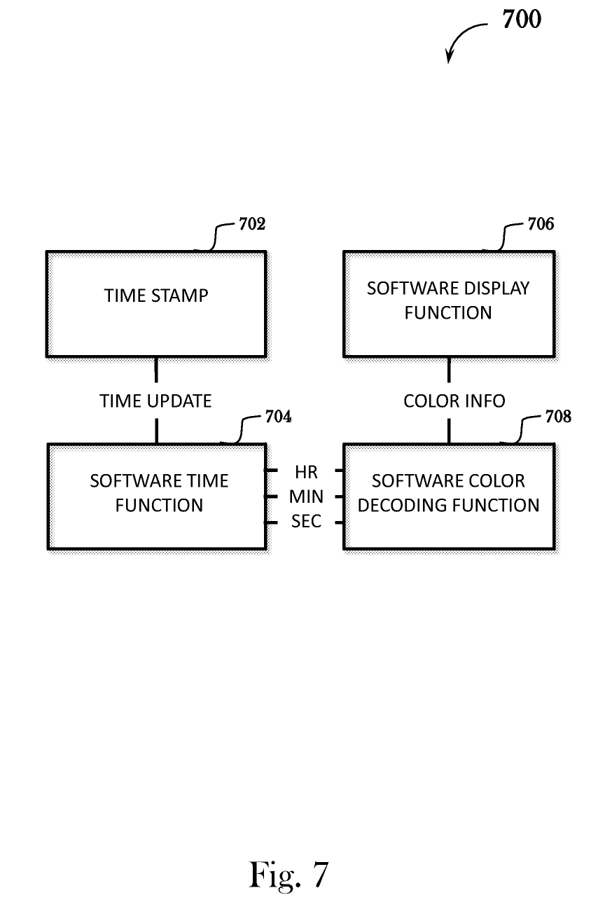

FIG. 7 is a system diagram of software application for providing time using colors, in accordance with an embodiment of the invention. In one embodiment, software application 700 includes a software time function 704 that accesses a time stamp 702, a software color decoding function 708, and a software display function 706. The time stamp 702 is a device that measurably marks the passage of time such as computer chip DS12885 by MAXIM SEMICONDUCTORS. The software time function 704 accesses the time stamp 702 and converts the measurable marks into hours, minutes, and seconds. The software color decoding function 708 associates the hours, minutes, and seconds from the software time function 704 with a given color group as described in reference to FIGS. 2 and 3 supra. The software display function 706 arranges and outputs the given color group on a display unit, such as an LCD, as described in reference to FIGS. 1 and 4 supra. In one particular embodiment, the software color decoding function 708 associates the hours, minutes, and seconds from the software time function 704 with a given symbol group as described in reference to FIGS. 5 and 6 supra. The software display function 706 then arranges and outputs the given symbol group on a display unit, such as an LCD, as described in various embodiments herein.

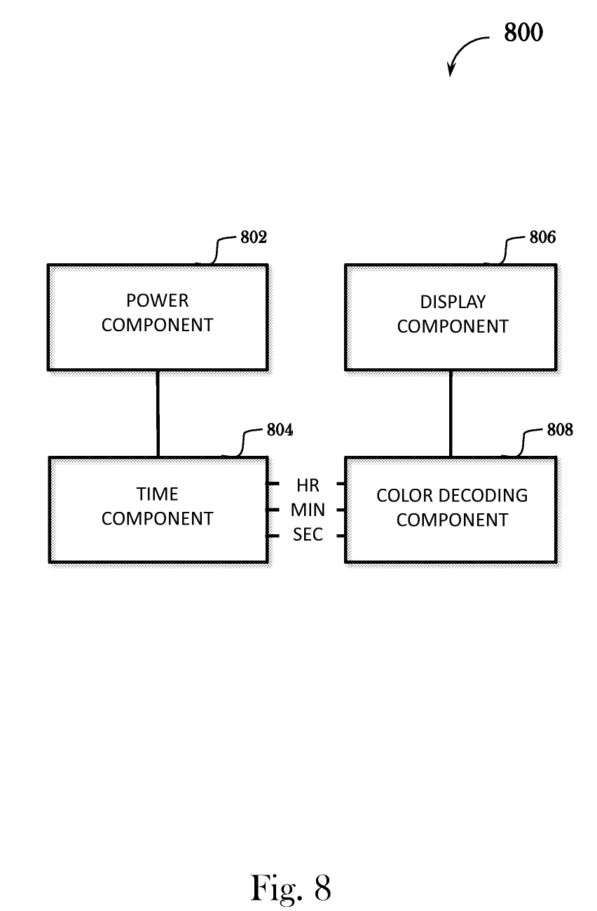

FIG. 8 is a system diagram of clock components for providing time using colors, in accordance with an embodiment of the invention. In one embodiment, system 800 includes a power component 802, a time component 804, a display component 806, and a color decoding component 808. The time component 804 produces measurable marks of time, such as computer chip DS12885 by MAXIM SEMICONDUCTORS. The color decoding component 808 associates the measurable marks of time with a given color group as described in reference to FIGS. 2 and 3 supra. The display component 806 visually displays the given color group as described in reference to FIGS. 1 and 4 supra. The power component 802 provides energy to the time component 804, the color decoding component 808, and the display component 806. In one particular embodiment, the color decoding component 808 associates the measurable marks of time with a given symbol group as described in reference to FIGS. 5 and 6 supra. The display component 806 then visually displays the given symbol group as described in various embodiments herein.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A clock for providing time using colors, the clock comprising:
a time component, the time component configurable to produce a measurable mark of time;
a color decoding component, the color decoding component configurable to associate the measurable mark of time with a given color group, the colors of the given color group being representative of numbers; and
a display component, the display component configurable to visually display the given color group in an arrangement,
wherein the displayed color group is usable to determine a time.

2. The clock of claim 1 wherein the given color group comprises an hour color, a 10-minute increment color, and a minute color, the hour color indicating a number of hours that have passed since a baseline, the 10-minute increment color indicating a number of ten minutes increments that have passed since a previous hour, and the minute color indicating a number of minutes that have passed since a previous ten minute increment.

3. The clock of claim 2 wherein the arrangement has a first section, a second section, and a third section, the first section being the hour color, the second section being the 10-minute increment color, and the third section being the minute color.

4. The clock of claim 3 wherein the arrangement is any of circular, vertical, horizontal, and object based.

5. The clock of claim 4 wherein the given color group further comprises an additional color, the additional color being any of an AM/PM color, a seconds color, a day of week color, a day of month color, a month color, and a year color, and wherein the arrangement has a fourth section, the fourth section being the additional color.

6. The clock of claim 5 wherein any of the colors of the given color group is substituted with a symbol, the symbol being representative of a number, and wherein the symbol is superimposed on the arrangement.

7. The clock of claim 6 wherein any of the colors, the color group, the symbol, and the arrangement are any of customizable and changeable.

8. The clock of claim 7 wherein the time component, the color decoding component, and the display component are embodied in any of a pocket watch, a wall clock, a standing clock, an alarm clock, a computer clock, a television clock, an appliance clock, a watercraft clock, an airplane clock, a telephone clock, and a personal digital assistant clock.

9. A software application for providing time using colors, the software application configurable to performing steps comprising:
receiving a measurable mark of time from a time component;
associating the measurable mark of time with a given color group, the colors of the given color group being representative of numbers; and
outputting the given color group for display in an arrangement,
wherein the displayed color group is usable to determine time.

10. The software application of claim 9 wherein the given color group comprises an hour color, a 10-minute increment color, and a minute color, the hour color indicating a number of hours that have passed since a baseline, the 10-minute increment color indicating a number of ten minutes increments that have passed since a previous hour, and the minute color indicating a number of minutes that have passed since a previous ten minute increment.

11. The software application of claim 10 wherein the arrangement has a first section, a second section, and a third section, the first section being the hour color, the second section being the 10-minute increment color, and the third section being the minute color.

12. The software application of claim 11 wherein the arrangement is any of circular, vertical, horizontal, and object based.

13. The software application of claim 12 wherein the given color group further comprises an additional color, the additional color being any of an AM/PM color, a seconds color, a day of week color, a day of month color, a month color, and a year color, and wherein the arrangement has a fourth section, the fourth section being the additional color.

14. The software application of claim 13 wherein any of the colors of the given color group is substituted with a symbol, the symbol being representative of a number, and wherein the symbol is superimposed on the arrangement.

15. The software application of claim 14 wherein any of the colors, the color group, the symbol, and the arrangement are any of customizable and changeable.

16. A clock for providing time using symbols, the clock comprising:
a time component, the time component configurable to produce a measurable mark of time;
a symbol decoding component, the symbol decoding component configurable to associate the measurable mark of time with a given symbol group, the symbols of the given symbol group being representative of numbers; and
a display component, the display component configurable to visually display the given symbol group in an arrangement,
wherein the displayed symbol group is usable to determine a time.

17. The clock of claim 16 wherein the given symbol group comprises an hour symbol, a 10-minute increment symbol, and a minute symbol, the hour symbol indicating a number of hours that have passed since a baseline, the 10-minute increment symbol indicating a number of ten minutes increments that have passed since a previous hour, and the minute symbol indicating a number of minutes that have passed since a previous ten minute increment.

18. The clock of claim 17 wherein the symbols are zodiac symbols.

19. The clock of claim 18 wherein any of the symbols of the given symbol group is substituted with a color, the color being representative of a number.

20. The clock of claim 19 wherein any of the symbols and the color are customizable.
